(19) United States
(12) Patent Application Publication
(10) Pub. No.: US 2009/0015061 A1
(43) Pub. Date: Jan. 15, 2009

(54) Switching Device

(76) Inventors: Maximilian Frank KOTSCHENREUTER, Oldenburg (DE); Jurgen Paul, Stutensee (DE); Rolf Merte, Marburg (DE); Volker Brichzin, Ludwigsburg (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/171,764

(22) Filed: Jul. 11, 2008

(30) Foreign Application Priority Data
Jul. 14, 2007 (DE) 102007032960.3

(51) Int. Cl. B60L 1/00

(52) U.S. Cl. 307/10.1

(57) ABSTRACT

The invention relates to a switching device for the switching of the power supply of a high-powered load of a motor vehicle comprising a vehicle electric system connector to be connected to the vehicle electric system of a motor vehicle, a load connector to be connected to the load, a control input for the activating of the switching device by means of an external control signal, a power semiconductor that is arranged as switch between the vehicle electric system connector and the load connector and an control unit for the control of the power semiconductor, being the control unit arranged between the control input of the switching device and a control input of the power semiconductor.

The invention relates to a switching device for the switching of the power supply of a high-powered load of a motor vehicle.

Heating devices such as, e.g., carburetor-air heaters of motor vehicles have a power of typically 1 kW and higher. As customary vehicle electric systems provide voltages of about 11 volts, resulting currents are of an order of magnitude of 100 amps. Mechanical relays are usually used for the switching of the power supply for carburetor-air heaters. These relays are, however, quite costly because they must be able to withstand electric arcs that may be generated by switching such high currents.

Also known are carburetor-air heaters with an integrated electronics system provided with a power semiconductor for the switching of the power supply. Although in such a manner it is possible to forego the costly mechanical relays this does not entail a considerable savings since the heat-resistant electronics of such a carburetor-air heater is, in such a case, of comparable costs.

Thus, the invention has the object to show how it is possible to connect in a more cost-effective manner the power supply to high-powered loads of a motor vehicle.

### SUMMARY OF THE INVENTION

In accordance with the invention, this object is attained by a switching device having the features set forth in claim 1. Other advantageous embodiments are the object of the dependent claims.

A switching device in accordance with the invention has considerable advantages:
A switching device in accordance with the invention is more cost-effective than the relays conventionally used in prior art for the switching of high currents. For the electronic control unit and the power semiconductor of the switching device according to the invention cost-effective standard components can be used since no specific heat-resistance is required. Like the relays customary in prior art the switching device can be arranged at a sufficient distance from a heat-generating load.
With a switching device in accordance with the invention it can be prevented that the vehicle electric system is overloaded by a load connected to the switching device. Some loads could draw in their starting phase an electrical power exceeding by far the rated power of the vehicle electric system. By means of the control unit of a switching device in accordance with the invention it is possible to attain a load current delimiting and an overvoltage protection by disconnecting the load.
The power semiconductor of the switching device in accordance with the invention can be used for pulse-width modulation. By means of pulse-width modulation it is possible to attain a starting current limitation so that the peak powers overloading the vehicle electric system can be prevented. Thus, a switching device in accordance with the invention renders it possible to choose the loads in a motor vehicle according to the rated currents generated in regular operation, which currents are frequently only a fraction of the highest possible starting currents of several hundred amps. By way of example, pumps for the secondary air system of a motor vehicle can be chosen in this manner according to their rated load because the power peaks occurring during the starting phase can be cut off by the switching device. The disconnecting of the peak powers by means of pulse-width modulation does merely result in that the pump starts up somewhat slower which is unimportant for the subsequent operation. Thus, it is possible to avoid pump cascades that, in prior art, are used to prevent high peak powers.

A switching device in accordance with the invention can be provided with an interface for a connecting to the bus system of an automobile. In such a manner, a central control unit of the vehicle can receive diagnostic data from the switching device and control unit according to need for activation of the load. The electronic control unit of the switching device can assume all detailed tasks regarding the control of the power semiconductor and the regulating of the switching intervals for the pulse-width modulation. Thus the central vehicle control unit can be relieved from processing work.

A switching device in accordance with the invention can be integrated into a handy housing and it is therefore excellent for the retrofitting of automobiles and the replacement of defective relays.
The switching device can be provided at low cost with a temperature sensor so that the load can be disconnected in the case of a dangerous heating up. In such a manner, the risk of a dangerous overheating, which in the worst scenario can lead to an automobile fire, can be drastically reduced.
With respect to the type of construction and the size of same, the switching device can be manufactured like the customary relays so that a retrofitting of automobiles and an exchange for mechanical relays can be easily performed.

### BRIEF DESCRIPTION OF THE DRAWINGS

Further details and advantages of the invention are explained by means of an embodiment making reference to the accompanying illustration. The therein described features can be made individually or in combination an object of claims.

FIG. 1 shows a circuit diagram of a switching device in accordance with the invention.

### DETAILED DESCRIPTION

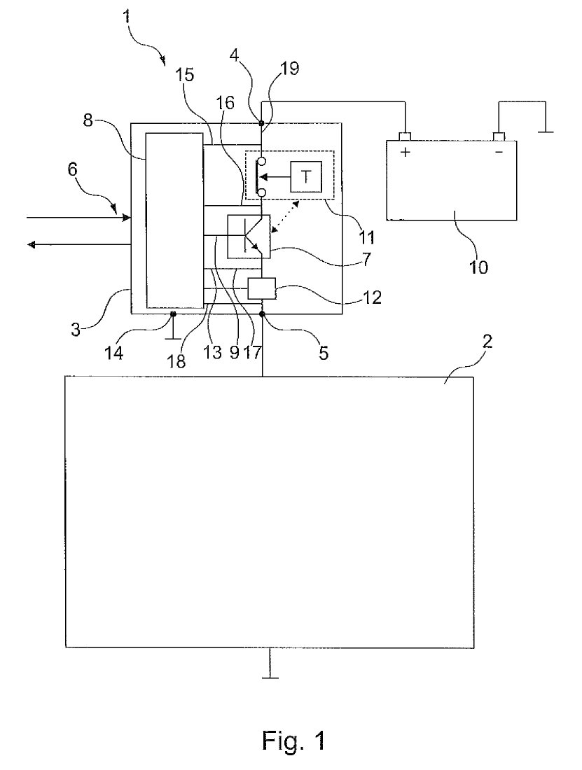

The switching device 1 shown in FIG. 1 is used for the switching of the power supply of a high-powered load 2 having a power of at least 500 W, especially more than 1 kW, installed in a motor vehicle. Such loads in a motor vehicle are usually heating installations such as, e.g., carburetor-air heaters, or the pump of a secondary air system, by means of which fresh air is blown into the hot exhaust blast during the start-up phase of a motor vehicle in order to oxidize not fully burned off gasoline rests and to attain better exhaust gas values.

The switching device 1 is provided with a housing 3 that carries a connector 4 for the connecting to the electric system of a motor vehicle, a load connector 5 for the connecting to the load 2, and a control input 6 for actuation of the switching device 1 by an external control signal. The connectors 4, 5 and the input 6 are configured for a plug-in connection. The connectors 4, 5 and the input 6 may be a plug or a socket. In the example shown the connectors 4, 5 and the input 6 are provided as sockets. The housing 3 encloses a power semiconductor 7, preferably a MOSFET, as switch between the vehicle electric system connector 4 and the load connector 5. The power semiconductor 7 is controlled by an electronic control unit 8 arranged in the housing 3, which unit is mounted between the control input 6 of the switching device 1 and a control input of the power semiconductor 7. The control unit 8 comprises a driver circuit for the control of the power semiconductor 7 and it is connected with a control output 9 to the control input of the power semiconductor 7.

During operation, the control unit 8 controls by means of pulse-width modulation the power output in time average to the connected load 2 in that it places the power semiconductor 7, connected to the control output 9, for short periods of time into its conducting state, so that the voltage generated by the vehicle battery 10 via the vehicle electric system connection 4 is applied to the load 2.

In the embodiment shown, the control input 6 of the switching device 1 is configured as interface to the electronic bus systems of the vehicle. Because of the interfacing to the bus system of a motor vehicle it is possible to exchange power and control data with a central control unit (not illustrated) of the vehicle. In particular, a central control unit of the vehicle can activate, via the bus interface, the switching device 1 to connect or disconnect the load 2 from a power supply. Additionally, the central control unit can also receive data on the status of the switching device 1. The interface 6 of the switching device 1 can be configured, e.g., for a customary bidirectional bus system such as CAN Low Speed, CAN High Speed, LIN, or the like. It is also possible to configure the interface 6 for a pulse-width modulated input signal or a digital switching signal as external control signal.

The switching device 1 is provided with a temperature sensor 11 between the connector 4 to vehicle electric system and the load connector 5. During operation the temperature sensor 11, interrupts the current flowing through the power semiconductor 7 when the temperature exceeds a critical temperature threshold. This temperature sensor 11 can be configured either as a mechanical temperature sensor or as an electronic temperature sensor.

The switching device 1 comprises a current-measuring device 12 for the measuring of the strength of the current flowing through the power semiconductor 7. The current-measuring device 12 is connected to a signal input 13 of the control unit 8. During operation, the measured values provided by the current-measuring device 12 are processed by the control unit 8 and, in the case of exceeding a threshold value, the power semiconductor 7 is actuated by the control unit 8 in order to interrupt the current flowing through the power semiconductor 7 between the vehicle electric system connector 4 and the load connector 5. In such a manner, it is possible to prevent an overloading of the vehicle electric system by an excessively high load current.

The switching device 1 comprises a ground connection 14 which, pursuant to specifications, is connected to ground and internally connected to a ground input of the control unit 8. The control unit 8 measures the strength of an electric voltage that is generated by a vehicle battery 10 connected to the vehicle electric system connector 4 of the switching device 1. The control unit 8 has for this purpose one or several measuring inputs 15, 16, 17, 18 that are connected to a line 19 extending between the vehicle electric system connector 4 and the load connector 5.

In the represented embodiment, a first measuring input 15 for the measuring of the voltage level applied to the vehicle electric system connector 4 is connected directly to same. Other measuring inputs 16, 17 are connected to the line 19 between the temperature sensor 11 and the power semiconductor 7 as well as on the side of the power semiconductor facing the load connection 5. The control unit 8 is configured in such a manner that in the case the measured voltage drops below a threshold it actuates the power semiconductor 7 in order to interrupt the current flowing through the power semiconductor 7 between the vehicle electric system connector 4 and the load connector 5. In such a manner, the illustrated switching device 1 can effect a delimiting of the starting current of the connected load.

Should the control unit 8 of the switching device 1 determine by processing the current or voltage values that the load 2 overloads the vehicle electric system or if it is overloaded itself due to an excessively high vehicle electric system voltage, an appropriate electric power can be applied to the load in time average by means of pulse-width modulation thus avoiding any damages.

### REFERENCE NUMBERS LIST

1 Switching device
2 Load
3 Housing
4 Vehicle electric system connector
5 Load connector
6 Control input
7 Power semiconductor
8 Control unit
9 Control output
10 Vehicle battery
11 Temperature sensor
12 Current measuring device
13 Signal input
14 Ground connection
15 Measuring input
16 Measuring input
17 Measuring input
18 Measuring input
19 Line

What is claimed is:

1. A switching device for the switching of the power supply of a high-powered load of a motor vehicle, comprising
a vehicle electric system connector to be connected to the vehicle electric system of a motor vehicle,
a load connector to be connected to the load,
a control input for controlling of the switching device by means of an external control signal,
a power semiconductor that is arranged as switch between the vehicle electric system connector and the load connector, and
a control unit for controlling of the power semiconductor, whereby the control unit is arranged between the control input of the switching device and a control input of the power semiconductor.

2. A switching device according to claim 1, which during operation controls by pulse-width modulation the electric power applied to a connected load.

3. A switching device according to claim 1, wherein the power semiconductor and the control unit are mounted in a housing which carries the vehicle electric system connector, the load connector and the control input.

4. A switching device according to claim 1, wherein the vehicle electric system connector and the load connector are configured for a plug in connection.

5. A switching device according to claim 1, wherein the vehicle electric system connector and the load connector each are a socket.

6. A switching device according to claim 1, wherein a temperature sensor is arranged between the vehicle electric system connector and the load connector.

7. A switching device according to claim 1, wherein the control unit comprises at least one measuring input for the measuring of the strength of an electric voltage.

8. A switching device according to claim 7, wherein the measuring input is connected to a line connecting the vehicle electric system connector and the load connector, and wherein the control unit is configured in such a manner that, in the case the measured voltage should drop below a threshold value, it actuates the power semiconductor in order to interrupt the current flowing through the power semiconductor between the vehicle electric system connector and the load connector.

9. A switching device according to claim 7, wherein the measuring input is connected to the line connecting the vehicle electric system connector and the load connector on the side of the power semiconductor facing the load connector.

10. A switching device according to claim 7, wherein one of the measuring inputs is connected to the line connecting the vehicle electric system connector and the load connector on the side of the power semiconductor facing the vehicle electric system connector.

11. A switching device according to claim 6, wherein both sides of the temperature sensor are each connected to a measuring input of the control unit.

12. A switching device according to claim 1 comprising a current measuring device for measuring of the strength of a current flowing during operation through the power semiconductor.

13. A switching device according to claim 1, wherein the signal input of the switching device is configured as an interface to the electronic bus system of the vehicle.

14. A switching device according to claim 1, comprising a ground connection which, according to specifications, is connected to ground and is internally connected to a measuring input of the control unit.
